(19) United States
(12) Patent Application Publication
(10) Pub. No.: US 2022/0044257 A1
(43) Pub. Date: Feb. 10, 2022

(54) ELECTRONIC DEVICE HAVING UNIQUE TICKET AND INFORMATION PROCESSING METHOD USING THE UNIQUE TICKET

(71) Applicant: AVISION INC., Hsinchu (TW)

(72) Inventor: CHUN-CHIEH LIAO, Hsinchu (TW)

(21) Appl. No.: 17/371,133

(22) Filed: Jul. 9, 2021

(30) Foreign Application Priority Data
Aug. 10, 2020 (TW) 109127089

(51) Int. Cl. G06Q 30/00; H04L 9/32

(52) U.S. Cl. CPC G06Q 30/0185; H04L 9/3263; G07B 1/00; G06Q 2220/00; G06Q 2230/00

(57) ABSTRACT

An electronic device having a unique ticket and an information processing method using the unique ticket are introduced. The information processing method is executed with the electronic device and includes obtaining at least one ticket datum and generating at least one unique code; including the unique code in the ticket datum; generating a tamper-proof on-file ticket datum according to the ticket datum having the unique code. By generating the tamper-proof on-file ticket datum according to the ticket datum having the unique code, it ensures the security of the tamper-proof on-file ticket datum. Furthermore, the unique code in the tamper-proof on-file ticket datum enables verification to be quickly performed, thereby enhancing ticket security and verification efficiency.

### CROSS-REFERENCE TO RELATED APPLICATION

This non-provisional application claims priority under 35 U.S.C. § 119(a) on Patent Application No(s). 109127089 filed in Taiwan, R.O.C. on Aug. 10, 2020, the entire contents of which are hereby incorporated by reference.

### BACKGROUND OF THE INVENTION

### 1. Field of the Invention

The present disclosure relates to electronic devices and information processing methods, and in particular to an electronic device having a unique ticket and an information processing method using the unique ticket.

### 2. Description of the Related Art

Owing to ever-changing technology, important electronic data are often transmitted via a network to cloud and computer apparatuses and stored therein. In doing so, the ease of accessing and processing data is enhanced, but the electronic data may be stolen, tampered or forged. To avoid this, important data are presented in paper format. This, however, has disadvantages as follows: counting, confirming and/or checking the paper-format data by hand are/is predisposed to human-made errors, fraudulent activities, and counterfeits. For instance, to finish an election, ballots are counted by hand, albeit at the risk of undercounting and overcounting the ballots, let alone adding to the difficulties in subsequent verification of the ballots. The aforesaid shortcomings also occur to receipts. Furthermore, manufacturers put marks and/or reference numbers on finished products to be delivered, in order to effectively control products finished and products delivered; however, related labels can be produced only upon confirmation of the presence of the marks and/or reference numbers on all items of the products. The labels are registered and thus cannot be increased, thereby being subjected to limitations placed by a control system. As a result, the aforesaid drawbacks of the prior art remain unsolved.

### BRIEF SUMMARY OF THE INVENTION

An objective of the present disclosure is to provide an electronic device having a unique ticket and an information processing method using the unique ticket. With the ticket bearing a unique datum, the ticket is unique. To count and verify the tickets, it is only necessary to inspect the unique data on the tickets to not only ensure the security of the tickets in terms of usage and preservation but also speed up ticket verification, so as to enhance ticket security and verification efficiency.

To achieve at least the above objective, the present disclosure provides an information processing method using a unique ticket, the method being executed with an electronic device, the method comprising the steps:

fetching at least one ticket datum and generating at least one unique code;

including the unique code in the ticket datum; and

generating a tamper-proof on-file ticket datum according to the ticket datum having the unique code.

Therefore, the acquisition of the ticket datum brings the generation of the unique code and the inclusion of the unique code in the ticket datum. The tamper-proof on-file ticket datum is generated according to the ticket datum having the unique code. The unique code of the tamper-proof on-file ticket datum not only ensures the security of the ticket datum in terms of use and preservation but also enables the unique code to be verified to speed up ticket verification, so as to enhance ticket security and verification efficiency.

To achieve at least the above objective, the present disclosure provides an electronic device having a unique ticket. The electronic device comprises:

an inputting unit for inputting data;

a storing unit for storing data;

an outputting unit for outputting data;

a processor connected to the inputting unit, the storing unit and the outputting unit, wherein the processor retrieves at least one ticket datum from the storing unit, generates at least one unique code, includes the unique code in the ticket datum, and generates a tamper-proof on-file ticket datum according to the ticket datum having the unique code.

Upon the acquisition of the ticket datum, the electronic device generates the unique code and includes the unique code in the ticket datum. The electronic device generates the tamper-proof on-file ticket datum according to the ticket datum having the unique code. The unique code of the tamper-proof on-file ticket datum not only ensures the security of the ticket datum in terms of use and preservation but also enables the unique code to be verified to speed up ticket verification, so as to enhance ticket security and verification efficiency.

### BRIEF DESCRIPTION OF THE DRAWINGS

FIG. 1 is a block diagram of an electronic device according to an embodiment of the present disclosure.

FIG. 2 is a schematic view of the process flow of an information processing method applicable to the electronic device shown in FIG. 1.

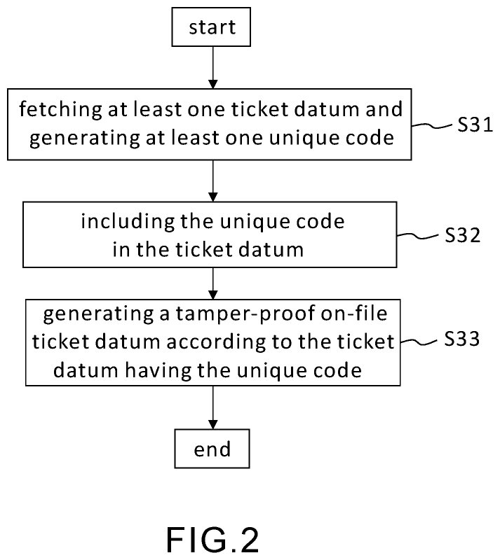

FIG. 3 is a block diagram of the electronic device according to another embodiment of the present disclosure.

FIG. 4 is a block diagram of the electronic device according to yet another embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

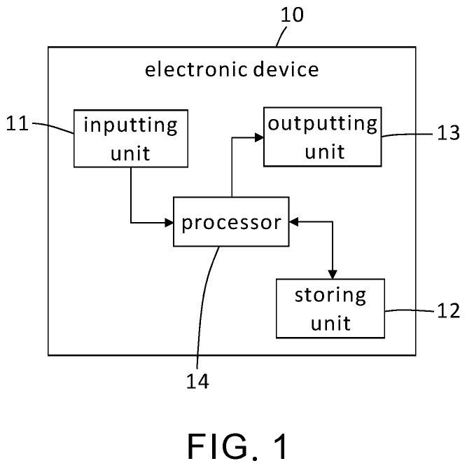

Referring to FIG. 1, in an embodiment of the present disclosure, an electronic device 10 having a unique ticket comprises an inputting unit 11, a storing unit 12, an outputting unit 13 and a processor 14. The processor 14 is connected to the inputting unit 11, the storing unit 12 and the outputting unit 13. In an embodiment, the electronic device 10 comprises a multifunction printer (MFP).

In an embodiment, the inputting unit 11 receives data. The inputting unit 11 comprises a scanner for receiving and scanning paper-based data to turn the paper-based data into related data and store the related data in the storing unit 12. The storing unit 12 stores the related data. The storing unit 12 comprises a memory, including but not limited to Dynamic Random Access Memory (DRAM), Flash memory, Hard Disk Drive (HDD), and Solid-State Drive (SSD). The outputting unit 13 outputs data. The outputting unit 13 comprises a printer for outputting related data in the form of paper-based data. The processor 14 processes related data. The processor 14 comprises a CPU.

Referring to FIG. 1, 2, in this embodiment, the electronic device 10 executes the information processing method using a unique ticket to generate a unique ticket. The method comprises the steps of:

fetching at least one ticket datum and generating at least one unique code (S31);

including the unique code in the ticket datum (S32); and

generating a tamper-proof on-file ticket datum according to the ticket datum having the unique code (S33).

The electronic device 10 executes step S31 first. In step S31, the processor 14 fetches at least one ticket datum from the storing unit 12 and generates at least one unique code according to the at least one ticket datum fetched.

The step where the processor 14 fetches at least one ticket datum from the storing unit 12 is illustrated by two embodiments as explained below.

In the first embodiment, a user instantly inputs at least one ticket datum to the electronic device 10 with the inputting unit 11, and the ticket datum thus input is stored in the storing unit 12. Then, the processor 14 instantly fetches the ticket datum from the storing unit 12. The user can input ticket data sequentially to the electronic device 10 with the inputting unit 11 and then store the ticket data in the storing unit 12. Then, the processor 14 fetches the input ticket data from the storing unit 12 instantly and sequentially.

In the second embodiment, the user pre-stores at least one ticket datum in the storing unit 12. It is only when the ticket datum is needed that the processor 14 can fetch the ticket datum from the storing unit 12. Similarly, ticket data can be pre-stored in the storing unit 12 once and for all.

In another embodiment, the processor 14 generates one unique code after fetching each ticket datum. For example, whenever the inputting unit 11 inputs and stores a ticket datum in the storing unit 12, the processor 14 instantly fetches the ticket datum from the storing unit 12 and generates a unique code accordingly. In another embodiment, the user can, once and for all, use the inputting unit 11 to input ticket data into the electronic device 10 and store the ticket data in the storing unit 12. Then, the processor 14 fetches the ticket data from the storing unit 12 and generates unique codes once and for all. For instance, it is only when the inputting unit 11 has input ticket data that the processor 14 fetches the ticket data from the storing unit 12 and generates unique codes accordingly.

Step S31 is followed by step S32. In step S32, the processor 14 includes the unique code in the ticket datum, such that the ticket datum has the unique code. The processor 14 attaches the unique code to the ticket datum, such that the unique code is included in the ticket datum.

In an embodiment, the unique code comprises a serial number and a category datum. The serial number comprises a dynamic continuous number. The category datum comprises a region datum, a polling booth datum, a subject datum, a time datum, a shop datum or an issue datum.

The dynamic continuous number increases by 1 when the processor 14 fetches a ticket datum. For example, the dynamic continuous number is initially A001. When the processor 14 fetches the first ticket datum, it generates the unique code A001 and includes the unique code in the first ticket datum, allowing the first ticket datum to include the dynamic continuous number A001. Furthermore, the processor 14 increases the dynamic continuous number by 1, such that the dynamic continuous number changes from A001 to A002. The unique code includes the dynamic continuous number, such that the ticket data are arranged in sequence and thus can be easily counted and checked. Thus, if a ticket datum is wrong, the sequence of preceding ticket data and subsequent ticket data can be confirmed according to their unique codes.

The region datum includes a zone number, zone code and zip code. The polling booth datum includes a polling booth's code and reference number. The subject datum includes a subject's code and reference number. The time datum includes year, month, day, hour and/or minute. The shop datum includes a shop's code, reference number, and phone number. The issue datum includes an issue number, issue reference number, and issue code.

Step S32 is followed by step S33. In step S33, the processor 14 generates a tamper-proof on-file ticket datum according to the ticket datum having the unique code. The tamper-proof on-file ticket datum includes the unique code. The processor 14 generates the tamper-proof on-file ticket datum, such that the ticket datum is tamper-proof and thus highly secure.

In an embodiment, the ticket datum having the unique code is in PDF format. The ways in which the processor 14 generates the tamper-proof on-file ticket datum are illustrated by embodiments below. The processor 14 executes a digital signature procedure to attach a digital certificate to the PDF-format ticket datum having the unique code and encrypt it, so as to generate the tamper-proof on-file ticket datum. If the tamper-proof on-file ticket datum is tampered, the digital certificate in the tamper-proof on-file ticket datum will disappear. Therefore, preservation security of the tamper-proof on-file ticket datum is ensured. The encryption involves encrypting the ticket datum with a public key and a private key.

In step S33, after the tamper-proof on-file ticket datum has been generated, the tamper-proof on-file ticket datum is further processed as illustrated by the two embodiments described below. In first embodiment, the processor 14 stores the tamper-proof on-file ticket datum storing and then controls the outputting unit 13 to output the tamper-proof on-file ticket datum in paper-based format.

In the second embodiment, the processor 14 controls the outputting unit 13 to output the tamper-proof on-file ticket datum in paper-based format, controls the inputting unit 11 to input an image of the tamper-proof on-file ticket datum and store the image in the storing unit 12. The image of the tamper-proof on-file ticket datum is stored in PDF format.

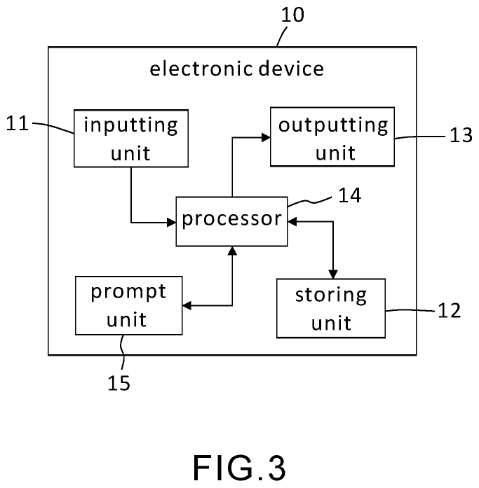

FIG. 3 illustrates another embodiment of the present disclosure. In this embodiment, the electronic device 10 further comprises a prompt unit 15. The prompt unit 15 is connected to the processor 14 and adapted to send a prompt. The prompt unit 15 comprises a speaker and a light-emitting unit, such as LED.

After the tamper-proof on-file ticket datum in paper-based format has been output, the electronic device 10 executes a ticket verification process to verify the tamper-proof on-file ticket datum as needed. During the ticket verification process, the processor 14 compares the tamper-proof on-file ticket datum obtained with the inputting unit 11 with the tamper-proof on-file ticket datum stored in the storing unit 12 to generate a comparison result and generates a prompt datum when the comparison result indicates that their unique codes are different. The processor 14 controls the prompt unit 15 to generate the prompt datum. The prompt datum is, for example, a prompt sound or a prompt light.

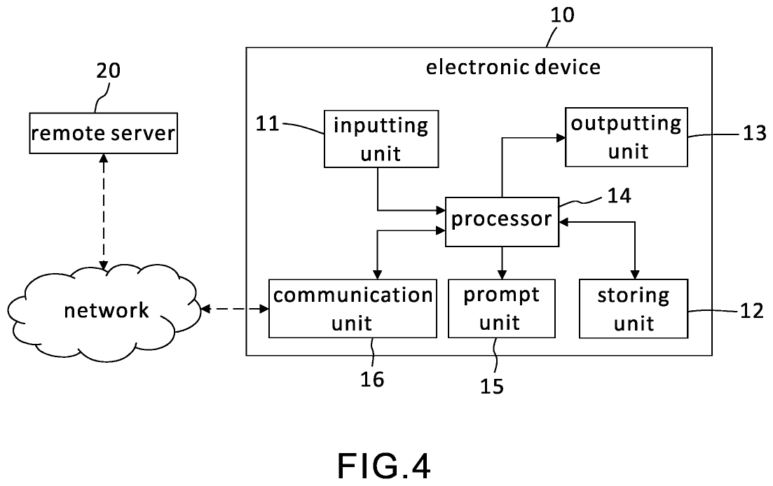

FIG. 4 illustrates yet another embodiment of the present disclosure. In this embodiment, the electronic device 10 is further connected to a remote server 20 by a network. The electronic device 10 comprises a communication unit 16. The communication unit 16 is connected to the processor 14 and is connected to the remote server 20 via the network. The communication unit 16 comprises a Wi-Fi unit or a 2G, 3G, 4G, 5G or higher mobile communication unit. The processor 14 controls the communication unit 16 to send the tamper-proof on-file ticket datum stored in the storing unit 12 to the remote server 20 for storage and preservation, thereby enhancing data security in terms of storage and preservation. In an embodiment, the remote server 20 is operated by a government or an enterprise.

Therefore, acquisition of the ticket datum brings the generation of the unique code and the inclusion of the unique code in the ticket datum. The tamper-proof on-file ticket datum is generated according to the ticket datum having the unique code. The unique code of the tamper-proof on-file ticket datum not only ensures the security of the ticket datum in terms of use and preservation but also enables the unique code to be verified to speed up ticket verification, so as to enhance ticket security and verification efficiency.

While the present disclosure has been described by means of specific embodiments, numerous modifications and variations could be made thereto by those skilled in the art without departing from the scope and spirit of the present disclosure set forth in the claims.

What is claimed is:

1. An information processing method using a unique ticket, the method being executed with an electronic device, the method comprising the steps of:
fetching at least one ticket datum and generating at least one unique code;
including the unique code in the ticket datum; and
generating a tamper-proof on-file ticket datum according to the ticket datum having the unique code.

2. The information processing method using a unique ticket according to claim 1, wherein the electronic device fetches the ticket datum according to an input ticket datum and generates the unique code accordingly, wherein the electronic device stores the tamper-proof on-file ticket datum and then outputs the tamper-proof on-file ticket datum.

3. The information processing method using a unique ticket according to claim 1, wherein the electronic device fetches the ticket datum according to a pre-stored ticket datum, wherein the electronic device outputs and then stores the tamper-proof on-file ticket datum.

4. The information processing method using a unique ticket according to claim 1, wherein the unique code comprises a serial number and a category datum.

5. The information processing method using a unique ticket according to claim 4, wherein the serial number comprises a dynamic continuous number, and the dynamic continuous number increases in response to each additional ticket datum fetched.

6. The information processing method using a unique ticket according to claim 5, wherein the category datum comprises a region datum, a polling booth datum, a subject datum, a time datum, a shop datum or an issue datum.

7. The information processing method using a unique ticket according to claim 6, wherein a digital certificate is not only attached to the ticket datum having the unique code but also encrypted to generate the tamper-proof on-file ticket datum.

8. The information processing method using a unique ticket according to claim 2, further comprising a ticket verification process, the ticket verification process comprising the step of fetching the output tamper-proof on-file ticket datum and comparing the unique code of the fetched output tamper-proof on-file ticket datum with the unique code of the stored tamper-proof on-file ticket datum to generate a comparison result.

9. The information processing method using a unique ticket according to claim 3, further comprising a ticket verification process, the ticket verification process comprising the step of fetching the output tamper-proof on-file ticket datum and comparing the unique code of the fetched output tamper-proof on-file ticket datum with the unique code of the stored tamper-proof on-file ticket datum to generate a comparison result.

10. The information processing method using a unique ticket according to claim 1, wherein the electronic device sends, via a network, the tamper-proof on-file ticket datum to a remote server for storage.

11. An electronic device having a unique ticket, comprising:
an inputting unit for inputting data;
a storing unit for storing data;
an outputting unit for outputting data; and
a processor connected to the inputting unit, the storing unit and the outputting unit,
wherein the processor retrieves at least one ticket datum from the storing unit, generates at least one unique code, includes the unique code in the ticket datum, and generates a tamper-proof on-file ticket datum according to the ticket datum having the unique code.

12. The electronic device having a unique ticket according to claim 11, wherein the at least one ticket datum is received via the inputting unit and stored in the storing unit, allowing the processor to retrieve the at least one ticket datum from the storing unit and generate the unique code accordingly, wherein the processor stores the tamper-proof on-file ticket datum in the storing unit and then outputs the tamper-proof on-file ticket datum with the outputting unit.

13. The electronic device having a unique ticket according to claim 11, wherein the processor retrieves the ticket datum according to the ticket datum pre-stored in the storing unit, wherein the processor controls the outputting unit to output the tamper-proof on-file ticket datum, then fetches the tamper-proof on-file ticket datum with the inputting unit, and stores the tamper-proof on-file ticket datum fetched in the storing unit.

14. The electronic device having a unique ticket according to claim 11, wherein the unique code comprises a serial number and a category datum.

15. The electronic device having a unique ticket according to claim 14, wherein the serial number comprises a dynamic continuous number, and the dynamic continuous number increases in response to each additional ticket datum fetched.

16. The electronic device having a unique ticket according to claim 14, wherein the category datum comprises a region datum, a polling booth datum, a subject datum, a time datum, a shop datum or an issue datum.

17. The electronic device having a unique ticket according to claim 11, wherein a digital certificate is not only attached to the ticket datum having the unique code but also encrypted to generate the tamper-proof on-file ticket datum.

18. The electronic device having a unique ticket according to claim 13, further comprising a prompt unit connected to the processor, wherein the processor obtains the output tamper-proof on-file ticket datum through the inputting unit and compares the unique code of the obtained output tamper-proof on-file ticket datum with the unique code of the tamper-proof on-file ticket datum stored in the storing unit to generate a comparison result, such that the prompt unit generates a prompt datum when the comparison result indicates that the unique code of the obtained output tamper-proof on-file ticket datum is different from the unique code of the tamper-proof on-file ticket datum stored in the storing unit.

19. The electronic device having a unique ticket according to 14, further comprising a prompt unit connected to the processor, wherein the processor obtains the output tamper-proof on-file ticket datum through the inputting unit and compares the unique code of the obtained output tamper-proof on-file ticket datum with the unique code of the tamper-proof on-file ticket datum stored in the storing unit to generate a comparison result, such that the prompt unit generates a prompt datum when the comparison result indicates that the unique code of the obtained output tamper-proof on-file ticket datum is different from the unique code of the tamper-proof on-file ticket datum stored in the storing unit.

20. The electronic device having a unique ticket according to claim 11, further comprising a communication unit connected to the processor and connected to a remote server by a network, wherein the tamper-proof on-file ticket datum is sent to the remote server with the communication unit by the processor and stored in the remote server.
